(19) United States
(12) Patent Application Publication
(10) Pub. No.: US 2018/0286098 A1
(43) Pub. Date: Oct. 4, 2018

(54) Annotation Transfer for Panoramic Image

(71) Applicant: Structionsite Inc., San Francisco, CA (US)

(72) Inventor: Philip Garcia Lorenzo, Sacramento, CA (US)

(73) Assignee: Structionsite Inc., San Francisco, CA (US)

(21) Appl. No.: 16/002,071

(22) Filed: Jun. 7, 2018

Related U.S. Application Data
(60) Provisional application No. 62/517,209, filed on Jun. 9, 2017.

(51) Int. Cl. G06T 11/60; H04N 5/232; G06T 3/00

(52) U.S. Cl. CPC G06T 11/60; G06T 3/0068; H04N 5/23238

(57) ABSTRACT

A method is provided. The method includes one or more of obtaining, with a 360 degree image capture device, a 360 degree image at a building location, annotating the 360 degree image at a selected coordinate, synchronizing a position of a mobile device to a position of the 360 degree image capture device for the 360 degree image, matching a mobile device live camera image zoom and orientation to the 360 degree image, and displaying the annotation on the mobile device live camera image.

### CROSS REFERENCE TO RELATED APPLICATION(S)

This application claims priority to earlier filed provisional application No. 62/517,209 filed Jun. 9, 2017 and entitled “CROWD-SOURCED AUGMENTED REALITY FOR CONSTRUCTION PROJECTS”, the entire contents of which are hereby incorporated by reference.

### FIELD

The present invention is directed to methods and systems for panoramic imaging for building sites, and more specifically annotation transfer of panoramic images onto building environments.

### BACKGROUND

360 degree images, also known as immersive images or spherical images, are images where a view in every direction is recorded at the same time, shot using an omnidirectional camera or a collection of cameras. During photo viewing on normal flat displays, the viewer has control of the viewing direction and field of view. It can also be played on a displays or projectors arranged in a cylinder or some part of a sphere. 360 degree photos are typically recorded using either a special rig of multiple cameras, or using a dedicated camera that contains multiple camera lenses embedded into the device, and filming overlapping angles simultaneously. Through a method known as photo stitching, this separate footage is merged into one spherical photographic piece, and the color and contrast of each shot is calibrated to be consistent with the others. This process is done either by the camera itself, or using specialized photo editing software that can analyze common visuals and audio to synchronize and link the different camera feeds together. Generally, the only area that cannot be viewed is the view toward the camera support.

360 degree images are typically formatted in an equirectangular projection. There have also been handheld dual lens cameras such as Ricoh Theta V, Samsung Gear 360, Garmin VIRB 360, and the Kogeto Dot 360—a panoramic camera lens accessory developed for the iPhone 4, 4S, and Samsung Galaxy Nexus.

360 degree images are typically viewed via personal computers, mobile devices such as smartphones, or dedicated head-mounted displays. Users may pan around the video by clicking and dragging. On smartphones, internal sensors such as gyroscopes may also be used to pan the video based on the orientation of the mobile device. Taking advantage of this behavior, stereoscope-style enclosures for smartphones (such as Google Cardboard viewers and the Samsung Gear VR) can be used to view 360 degree images in an immersive format similar to virtual reality. The phone display is viewed through lenses contained within the enclosure, as opposed to virtual reality headsets that contain their own dedicated displays.

### SUMMARY

The present invention is directed to solving disadvantages of the prior art. In accordance with embodiments of the present invention, a method is provided. The method includes one or more of obtaining, with a 360 degree image capture device, a 360 degree image at a building location, annotating the 360 degree image at a selected coordinate, synchronizing a position of a mobile device to a position of the 360 degree image capture device for the 360 degree image, matching a mobile device live camera image zoom and orientation to the 360 degree image, and displaying the annotation on the mobile device live camera image.

In accordance with another embodiment of the present invention, a system is provided. The system includes one or more of a 360 degree image capture device and a mobile device. The 360 degree image capture device is configured to create a 360 degree image of a building location, and the 360 degree image includes annotation at one or more selected coordinates. The mobile device includes a display, a camera, a memory, and a processor coupled to the memory, the display, and the camera. The memory includes an application and the annotated 360 degree image, which is received from one of the 360 degree image capture device or a computer configured to add annotation to the 360 degree image. The processor is configured to execute the application to one or more of synchronize a position of the mobile device to a 360 degree image capture device position for the annotated 360 degree image, match a mobile device live camera view zoom and orientation to the annotated 360 degree image, and display the annotation on the mobile device live camera view.

In accordance with yet another embodiment of the present invention, a non-transitory computer readable storage medium is provided. The non-transitory computer readable storage medium configured to store instructions that when executed cause a processor to perform one or more of obtaining, with a 360 degree image capture device, a 360 degree image at a building location, annotating the 360 degree image at a selected coordinate, synchronizing a position of a mobile device to a position of the 360 degree image capture device for the 360 degree image, matching a mobile device live camera image zoom and orientation to the 360 degree image, and displaying the annotation on the mobile device live camera image.

One advantage of the present invention is that it provides a method and system for visual collaboration around the context of a building construction site. Various forms of annotation may be added by several users to a 360 degree image file in order to create a rich media presentation that conveys additional information to a mobile device user at a later time.

One advantage of the present invention is that it provides a method for providing specific annotation at a specific position on a 360 degree image, thereby drawing a viewer's attention to a specific graphic or text information at a specific point in a building.

Another advantage of the present invention is that it allows any type of 360 degree image to be used as the basis for user-added annotation. A 360 degree camera image or a 360 degree laser scan may be used, or a 360 degree rendering from a 3D model.

Additional features and advantages of embodiments of the present invention will become more readily apparent from the following description, particularly when taken together with the accompanying drawings. This overview is provided to introduce a selection of concepts in a simplified form that are further described below in the detailed description. It may be understood that this overview is not intended to identify key features or essential features of the claimed subject matter, nor is it intended to be used to limit the scope of the claimed subject matter.

### BRIEF DESCRIPTION OF THE DRAWINGS

FIG. 1 is a diagram illustrating a 360 degree image capture system in accordance with embodiments of the present invention.

FIG. 2 is a diagram illustrating camera view adjustment in accordance with embodiments of the present invention.

FIG. 3 is a diagram illustrating an annotated 360 degree image in accordance with embodiments of the present invention.

FIG. 4 is a diagram illustrating a synchronized mobile device position in accordance with embodiments of the present invention.

FIG. 5 is a diagram illustrating matching a transparency overlay to a live camera image in accordance with embodiments of the present invention.

FIG. 6 is a diagram illustrating matched zoom and orientation in accordance with embodiments of the present invention.

FIG. 7 is a diagram illustrating 360 degree image capture and mobile device position on a floor plan in accordance with embodiments of the present invention.

FIG. 8 is a block diagram illustrating a mobile device in accordance with embodiments of the present invention.

FIG. 9 is a flow diagram illustrating panoramic image transfer in accordance with embodiments of the present invention.

FIG. 10 is a flowchart illustrating a panoramic image annotation process in accordance with embodiments of the present invention.

### DETAILED DESCRIPTION

The present invention utilizes various technologies to allow for the creation of annotations on images to be locatable/referenced back into an actual physical location that the annotation is intended to refer to. For example, if someone annotates a photo to indicate that there is an issue with construction, that exact annotation may be easily located on the physical construction site by others for fixing via a mobile device.

Prior to the present application, people would annotate a photo and include text as to where exactly the photo should be found (e.g. Level 1, gridline 2, north). This description of where the issue can be found is often too broad and extra time must be spent to actually locate what the annotation in the photo is referring to in the physical environment. The present application provides an improvement by removing the need for additional supporting text to describe the location of the photo, by ensuring that the photo itself is captured in such a way as to already have location information embedded within it.

The processes of the present application advantageously allows an individual to locate the annotation at an actual building location in order to save time in finding the annotation and immediately act on it. In construction, a jobsite may change frequently. By aligning oneself to some unchanged parts, one can see the “original” condition (so the old photo itself is useful).

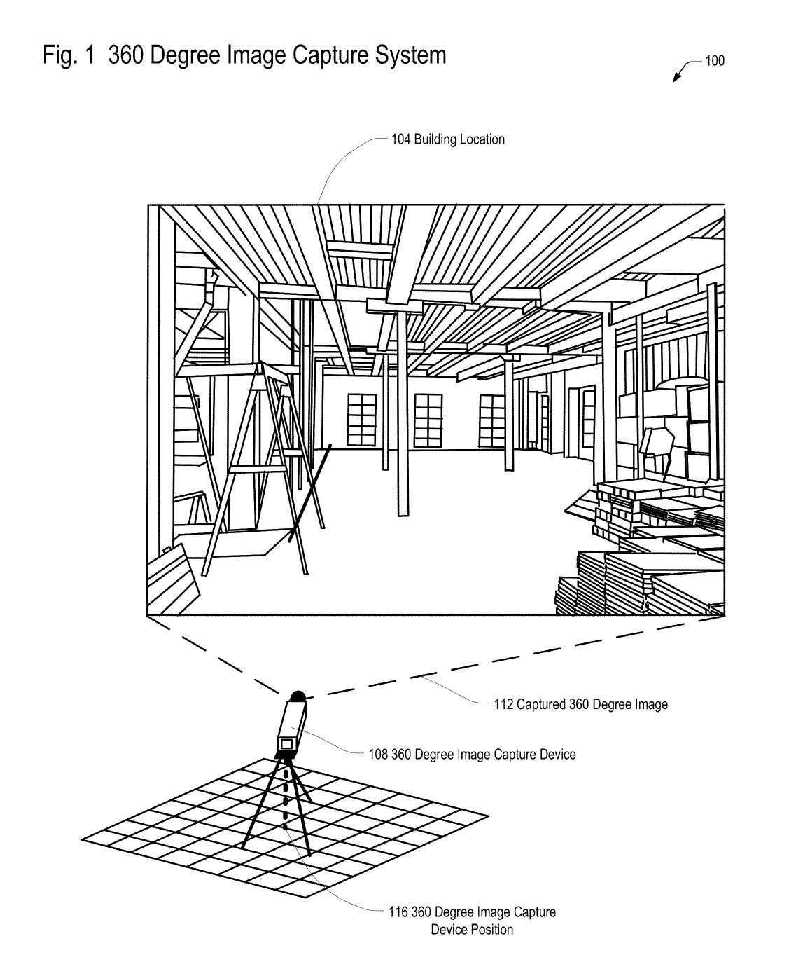

Referring now to FIG. 1, a diagram illustrating a 360 degree image capture system 100 in accordance with embodiments of the present invention is shown. FIG. 1 illustrates an interior building location 104 that is a construction site in the preferred embodiment. A construction site may include a building location in a state of assembly or construction, various types, quantities, and locations of building materials, tools, construction refuse or debris, and so forth. Construction workers or other personnel may or may not be present.

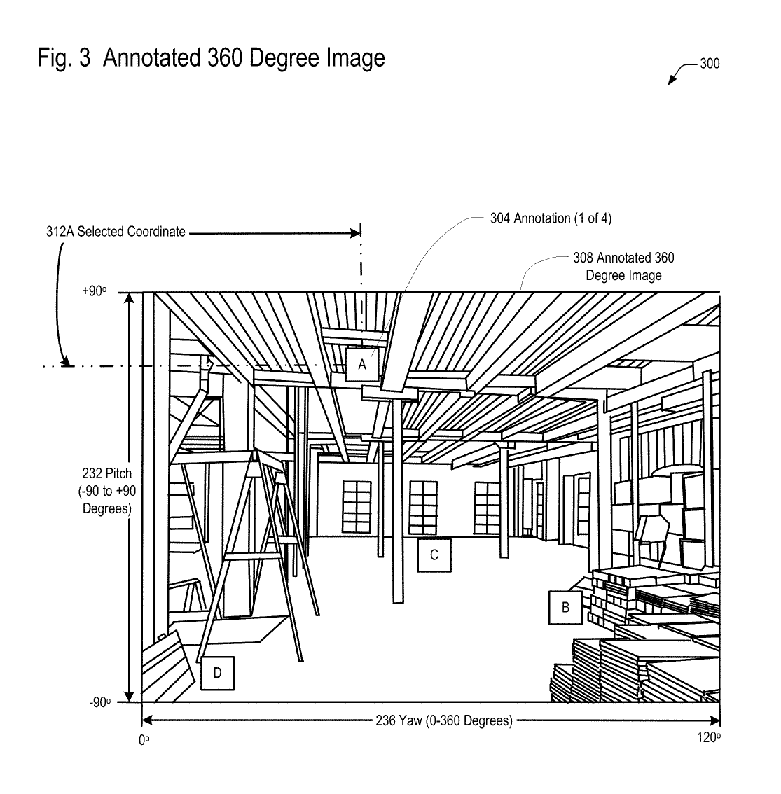

The 360 degree image capture system 100 includes a 360 degree image capture device 108. In one embodiment, the 360 degree image capture device 108 is a 360 degree camera. In another embodiment, the 360 degree image capture device 108 is a 360 degree laser scanner with photo export capability. The 360 degree image capture device 108 is placed at a specific location 116 at the building location. For example, the specific location 116 may be identified by a latitude, longitude, and height from a floor. Alternately, the specific location 116 may be designated by a position on a building floor plan at a specific height. Once positioned at the specific location 116, a 360 degree image is captured 112 by the 360 degree image capture device 108. In one embodiment, the 360 degree image 112 is stored as a file in a memory device of the 360 degree image capture device 108, such as an SD Card or USB memory. In another embodiment, the 360 degree image capture device 108 includes a wired or wireless interface that transfers the captured 360 degree image 112 to another location such as a server or mobile device 404. A single image 112 or multiple images 112 may be captured, and may be captured at different positions 116 and/or with different orientations, zoom levels, or other viewing properties. Although the building location 104 is represented throughout the drawings herein as a non-panoramic image for simplicity and ease of understanding, it should be understood that the captured 360 degree camera image 112 is a true 360-degree image with image content at all 360 degrees around the 360 degree image capture device position 116 (i.e. all 360 degrees of yaw 236 as shown in FIG. 3).

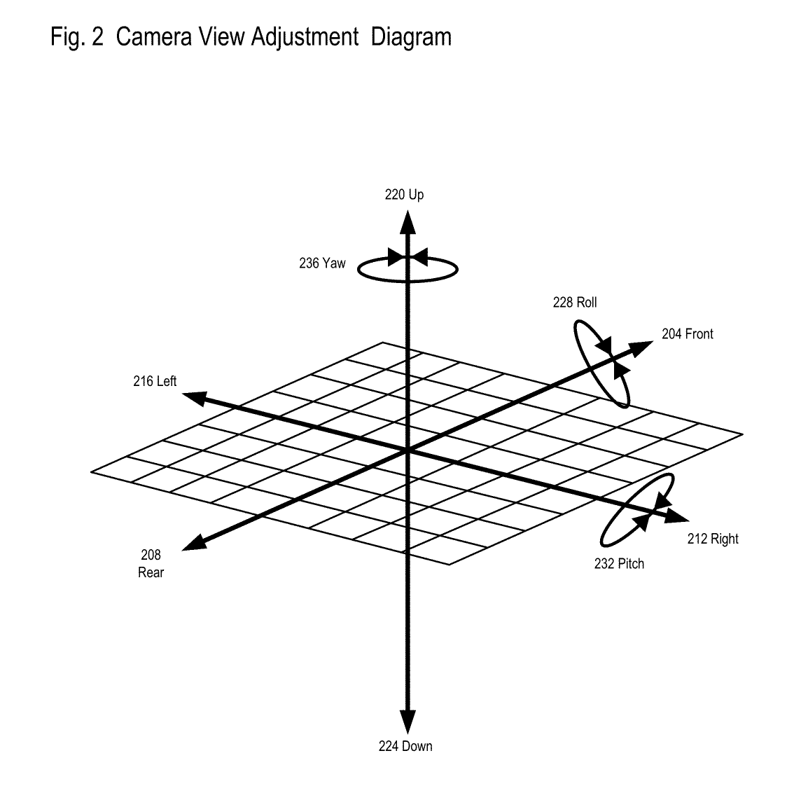

Referring now to FIG. 2, a diagram illustrating camera view adjustment in accordance with embodiments of the present invention is shown. FIG. 2 illustrates various camera adjustments relative to x, y, and z dimensions. The x dimension may be viewed as left 216 to right 212. The y dimension may be viewed as up 220 to down 224. The z dimension may be viewed as front 204 to rear 208. Each dimension may also have a rotation about one of the three axes. A rotation around the x dimension (left-right axis) is pitch 232, and from a camera position at the center of the diagram is viewed as up or down motion. A rotation around the y dimension (up-down axis) is yaw 236, and from a camera position at the center of the diagram is viewed as left or right motion. A rotation around the z dimension (front-rear axis) is roll 228, and from a camera position at the center of the diagram is viewed as tilting left or right motion.

When specifying a specific camera view, it is important to specify several parameters. First, the camera position 116 specifies a specific position in proximity to the building location 104. Next, an orientation of roll 228, pitch 232, and yaw 236 values yields a specific pointing direction in 3-dimensional space. As long as the camera or 360 degree image capture device 108 is maintained in an untilted (no roll 228) attitude, only pitch 232 and yaw 236 values need to be specified. In some embodiments, a gyroscopic device may provide any required roll 228, pitch 232, or yaw 236 values.

One other parameter needs to be provided in order to fully specify a camera view: field of view. The camera or other image capture device 108 has a lens which may or may not be adjustable. The field of view is a standard measurement (i.e. a 360 field of view of a 360 degree camera, a 90 degree field of view from a standard camera, etc.).

Referring now to FIG. 3, a diagram illustrating an annotated 360 degree image 300 in accordance with embodiments of the present invention is shown. FIG. 3 illustrates the captured 360 degree image of FIG. 1, after four annotations 304 have been added. At least one annotation 304 must be included with the annotated 360 degree image 300, and must be included within all boundaries of the captured 360 degree image 112. Annotation(s) 304, when added to the 360 degree image, create an annotated 360 degree image 308.

Annotations 304 may be any form of text or graphics added to the 360 degree image 112 in order to provide more information to the 360 degree image. For example, annotation 304 may include relevant text such as “pipe location too far left” or “add additional support here”, in order to describe a current state of construction and possibly provide instruction to others. Annotation 304 may also include descriptive graphics such as a directional arrow or a circled item in the 360 degree image. Annotation 304 may also include a combination of any text or graphics. Annotation 304 may also specify one or more colors the annotation 304 will appear as in the annotated 360 degree image, or a line width for the annotation 304. Different colors and line widths may be used for different annotations 304. Annotation may also include an identifier (alphanumeric or symbol) that references a comment/description in a row of a table, for example.

Each annotation 304 present in the annotated 360 degree image 308 has a corresponding selected coordinate 312. Thus, for annotation A 304, there is a corresponding selected coordinate 312A, for annotation B 304, there is a corresponding selected coordinate 312B, for annotation C 304, there is a corresponding selected coordinate 312C, and for annotation D 304, there is a corresponding selected coordinate 312D. Each selected coordinate 312 includes a pitch 232 and a yaw 236 value. Pitch values 232 range from a minimum of −90 degrees to a maximum of +90 degrees. Yaw values 236 range from a minimum of 0 degrees to a maximum of 360 degrees (where, obviously, 0 degrees is the same view as 360 degrees). Therefore, for each annotation 304 present in an annotated 360 degree image 308, there is a corresponding pitch 232 and yaw 236 value, assuming that the camera or image capture device 108 is not rolled 228, as previously described. For illustration purposes, FIG. 3 only shows approximately 120 degrees of yaw 236, instead of the full 360 degrees of the annotated 360 degree image 308.

In one embodiment, annotations 304 are added to the 360 degree image 112 by users of the 360 degree image capture device 108, with the device 108. However, in some cases the 360 degree image capture device 108 may lack an add annotation 304 capability, and only be capable of capturing, storing, or transferring 360 degree images 112. In such cases, it may be necessary to transfer the captured 360 degree image 112 to another computer (not shown), where one or more users may add one or more annotations 304 to create the annotated 360 degree camera image 308. In either case, the annotated 360 degree image 308 is transferred to a mobile device 404.

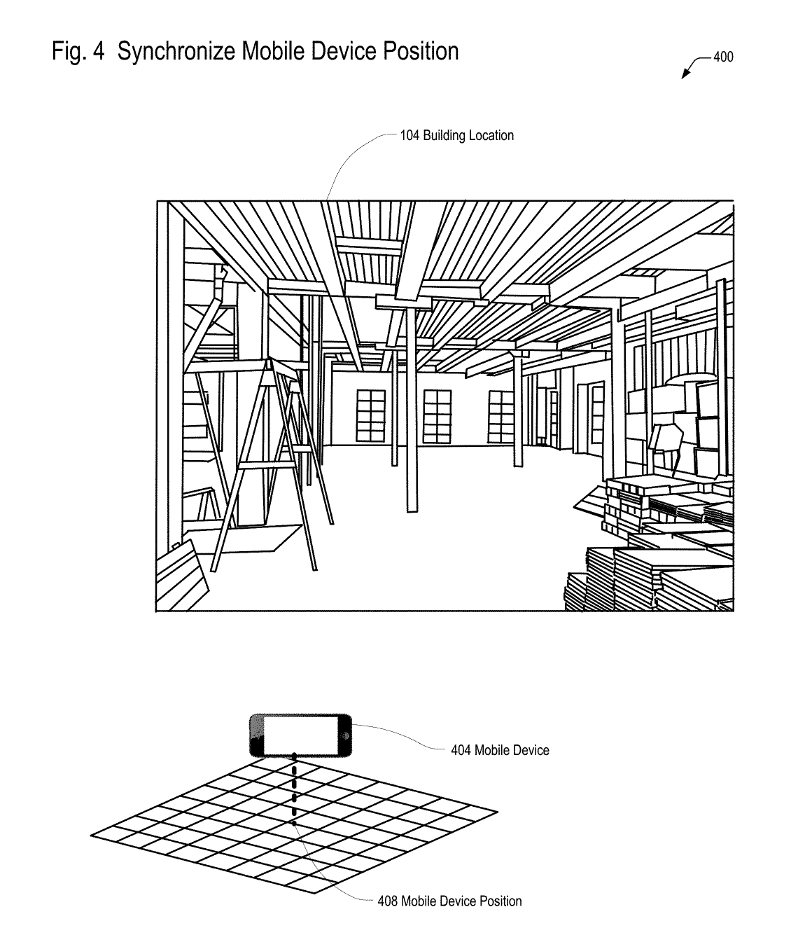

Referring now to FIG. 4, a diagram illustrating a synchronized mobile device position 400 in accordance with embodiments of the present invention is shown. FIG. 4 shows a mobile device 404 present at the building location 104. The mobile device 404 is positioned 408 at the same location as the 360 degree image capture device 108 in FIG. 1. Therefore, the mobile device position 408 will match the 360 degree image capture device position 116. This means the latitude/longitude, GPS coordinates, or other horizontal position, and vertical height will be the same between both devices 108, 404. From a time point of view, the mobile device 404 positioning step of FIG. 4 follows the 360 degree image capture device 108 positioning step of FIG. 1.

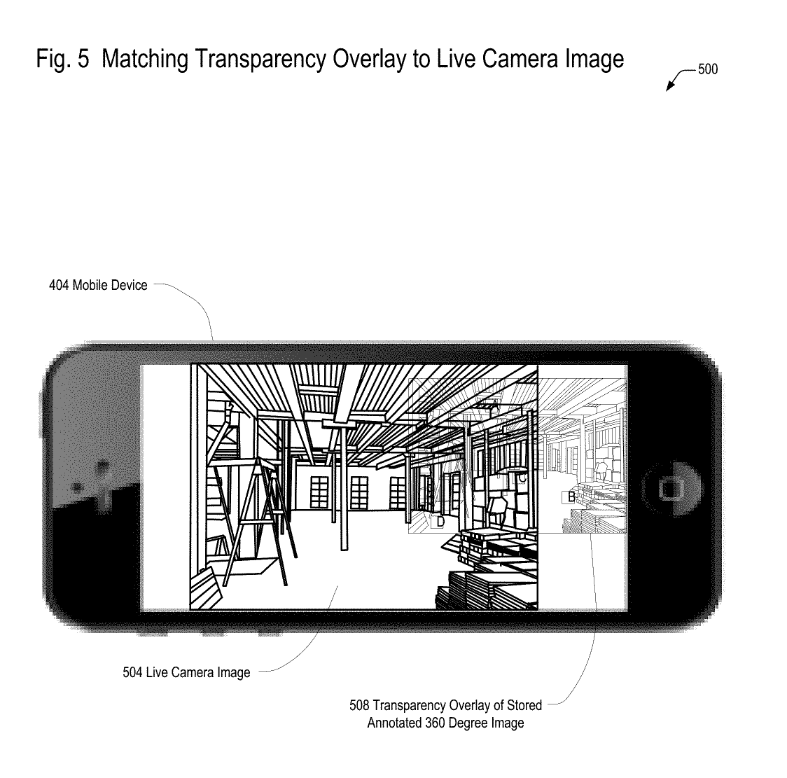

Referring now to FIG. 5, a diagram illustrating matching a transparency overlay to a live camera image 500 in accordance with embodiments of the present invention is shown. By this time, the annotated 360 degree image 308 has been received by the mobile device 404 and stored in mobile device memory 808. In one embodiment, a user associated with the 360 degree image capture device 108 transfers the annotated 360 degree image 308 to the mobile device 404 by a text message attachment, email attachment, ftp transfer, Bluetooth transfer, or other means. In another embodiment, a user associated with one or more of the annotations 304 transfers the annotated 360 degree image 308 to the mobile device 404 by a text message attachment, email attachment, ftp transfer, Bluetooth transfer, or other means. In yet another embodiment, a user associated with the mobile device 404 reads the annotated 360 degree image 308 from the 360 degree image capture device 108 or another computer, and stores the annotated 360 degree image 308 in a memory 808 of the mobile device 404.

Once the mobile device 404 has been positioned 408 at the same location 116 as the 360 degree image capture device 108, a camera 832 in the mobile device 404 is activated in order to display a live camera image 504 on a display screen 828 of the mobile device 404. The live camera image 504 may be generally centered on the mobile device display 828.

Next, a transparency overlay 508 of the stored annotated 360 degree image is also displayed on the mobile device 404. In one embodiment, an application 816 is invoked on the mobile device 404 to allow a mobile device user to search for and select stored images on the mobile device 404, including one or more annotated 360 degree images 308 stored in the mobile device memory 808. In one embodiment, the transparency overlay 508 is a “ghosted” image that allows users to see an underlying image, including the live camera image 504. In one embodiment, the application 816 allows a user of the mobile device 404 to move, contract, and expand the transparency overlay 508 in order to most closely match the boundaries of the live camera image 504.

In lieu of manually matching the transparency overlay 508 to the live camera image 504, an automated matching process may be used. A computer vision or live photogrammetric application 816 in the mobile device 404 may be used to automatically align and adjust the live camera image 504 of the mobile device 404 to the annotated 360 degree image 308. The application may dynamically adjust both zoom and orientation. In response to the live camera image 504 of the mobile device 404 matching the annotated 360 degree image 308, the application 816 provides an indication to the mobile device user.

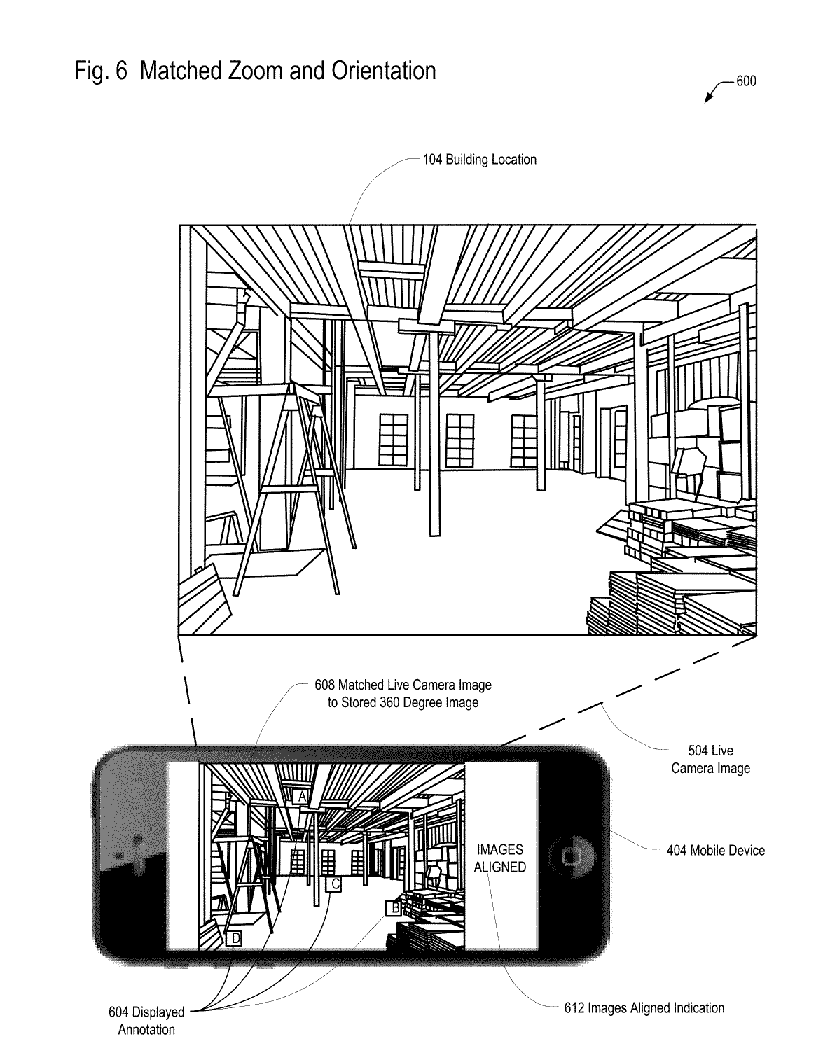

Referring now to FIG. 6, a diagram illustrating matched zoom and orientation 600 in accordance with embodiments of the present invention is shown. FIG. 6 illustrates the mobile device 404 simultaneously displaying the live camera image 504 overlaid with the annotated 360 degree image 308, such that the images match as closely as possible. By adjusting the zoom and orientation of the live camera image 504 with camera 832 controls on the mobile device 404, a matched live camera image to the stored 360 degree image 608 is displayed. When the two images are properly matched on the mobile device display 828, an appropriate indication of images aligned 612 is presented to the user of the mobile device 404. In one embodiment, a text indication such as “Images Aligned” is displayed. In another embodiment, an audible tone is generated by the mobile device 404 to provide the images aligned indication 612. In another embodiment, a prerecorded audio message such as “Images Aligned” is generated by the mobile device 404 to provide the images aligned indication 612. When the images are aligned/matched 608, the positions of displayed annotation 604 (from the annotated 360 degree image 308) are identical to the positions of displayed annotation 304.

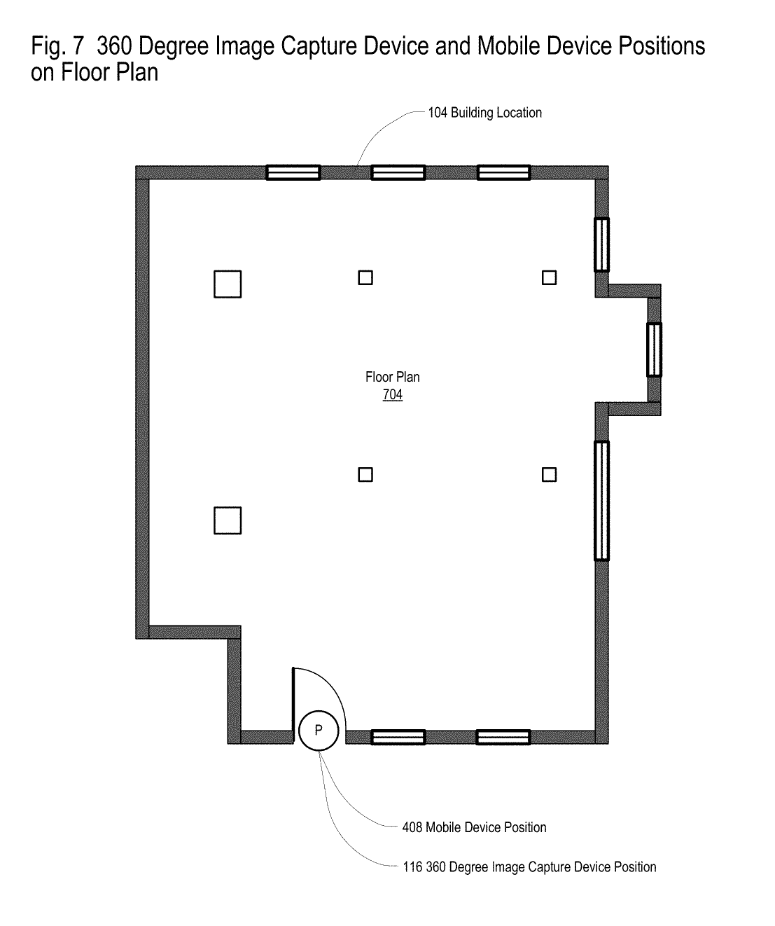

Referring now to FIG. 7, a diagram illustrating 360 degree image capture and mobile device position on a floor plan in accordance with embodiments of the present invention is shown. A floor plan 704 is a two dimensional representation of a building location 104, viewed from an overhead perspective. The floor plan 704 displays walls, windows, doors, stairs, and structural features such as columns. In one embodiment, the mobile device position 408 is indicated on the floor plan 704. In the preferred embodiment, the floor plan 704 is a file stored in the mobile device memory 808 and displayed on the mobile device display 828.

In an alternative embodiment to using latitude/longitude to specify mobile device position 408, the mobile device position 408 may be specified on a floor plan 704 displayed on the mobile device 404. In other alternative embodiments, the mobile device position 408 may be determined by receiving location information in a Quick Response (QR) code, receiving location coordinates 840 of the mobile device 404, and receiving an indoor positioning signal.

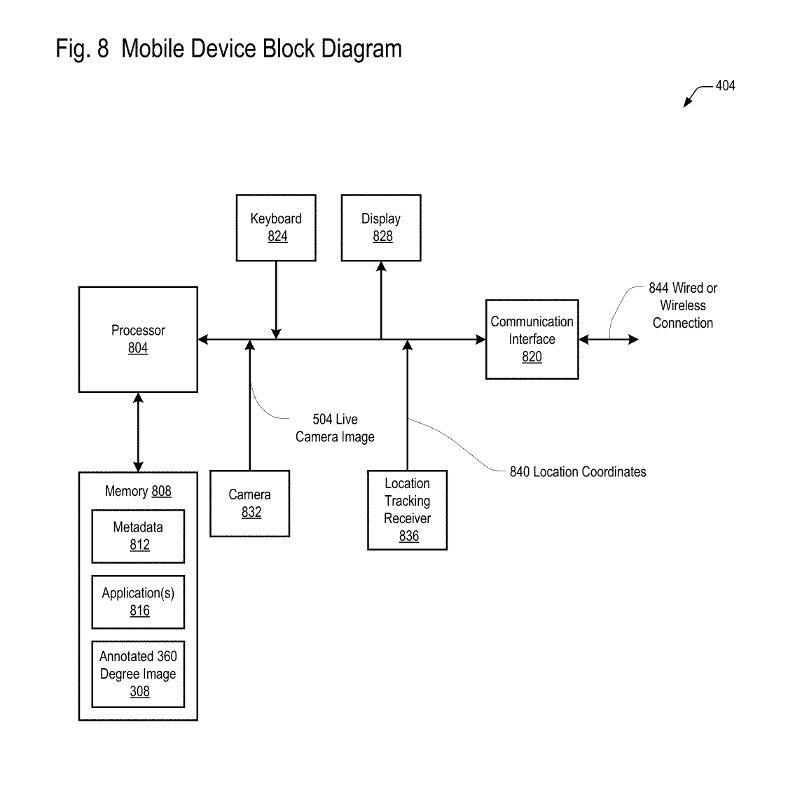

Referring now to FIG. 8, a block diagram illustrating a mobile device 404 in accordance with embodiments of the present invention is shown. The mobile device 404 is a portable computer, and may be any type of computing device including a smart phone, a tablet, a pad computer, a laptop computer, a notebook computer, a wearable computer such as a watch, or any other type of computer.

The mobile device 404 includes one or more processors 804, which run an operating system and applications 816, and control operation of the mobile device 404. The processor 804 may include any type of processor known in the art, including embedded CPUs, RISC CPUs, Intel or Apple-compatible CPUs, and may include any combination of hardware and software. Processor 804 may include several devices including field-programmable gate arrays (FPGAs), memory controllers, North Bridge devices, and/or South Bridge devices. Although in most embodiments, processor 804 fetches application 816 program instructions and metadata 812 from memory 808, it should be understood that processor 804 and applications 816 may be configured in any allowable hardware/software configuration, including pure hardware configurations implemented in ASIC or FPGA forms.

The display 828 may include control and non-control areas. In most embodiments, controls are “soft controls” shown on the display 828 and not necessarily hardware controls or buttons on mobile device 404. In other embodiments, controls may be all hardware controls or buttons or a mix of “soft controls” and hardware controls. Controls may include a keyboard 824, or a keyboard 824 may be separate from the display 828. The display 828 displays video, snapshots, drawings, text, icons, and bitmaps.

In the preferred embodiment, the display 828 is a touch screen whereby controls may be activated by a finger touch or touching with a stylus or pen. One or more applications 816 or an operating system of the mobile device 404 may identify when the display 828 has been tapped and a finger, a stylus or a pointing device has drawn on the display 828 or has made a selection on the display 828 and may differentiate between tapping the display 828 and drawing on the display 828. In some embodiments, the mobile device 404 does not itself include a display 828, but is able to interface with a separate display through various means known in the art.

Mobile device 404 includes memory 808, which may include one or both of volatile and nonvolatile memory types. In some embodiments, the memory 808 includes firmware which includes program instructions that processor 804 fetches and executes, including program instructions for the processes disclosed herein. Examples of non-volatile memory 808 include, but are not limited to, flash memory, SD, Erasable Programmable Read Only Memory (EPROM), Electrically Erasable Programmable Read Only Memory (EEPROM), hard disks, and Non-Volatile Read-Only Memory (NOVRAM). Volatile memory 808 stores various data structures and user data. Examples of volatile memory 808 include, but are not limited to, Static Random Access Memory (SRAM), Dual Data Rate Random Access Memory (DDR RAM), Dual Data Rate 2 Random Access Memory (DDR2 RAM), Dual Data Rate 3 Random Access Memory (DDR3 RAM), Zero Capacitor Random Access Memory (Z-RAM), Twin-Transistor Random Access Memory (TTRAM), Asynchronous Random Access Memory (A-RAM), ETA Random Access Memory (ETA RAM), and other forms of temporary memory.

In addition to metadata 812 and application(s) 816, memory 808 may also include one or more video & audio player application(s) including a 360 degree photo viewer application. The video & audio player application(s) 816 may play back received annotated 360 degree images, and aids the user experience. Metadata 812 may include various data structures in support of the operating system and applications 816, such as a mobile device position 408 or a 360 degree image capture device position 116.

Communication interface 820 is any wired or wireless interface 844 able to connect to networks or clouds, including the internet in order to transmit and receive annotated 360 degree images 308, live camera images 504, matched live camera image to stored 360 degree images 608, or floor plans 704.

In most embodiments mobile device 404 includes a camera 832, which produces a live camera image 504 used by one or more applications 816 and shown on display 828. A camera 832 may be either a 360 degree or panoramic camera, or a non-panoramic device producing a fixed angle image. In some embodiments, mobile device 404 includes both a front camera 832A as well as a rear camera 832B as well as a means to switch the camera image 504 between the front camera 832A and the rear camera 832B. In other embodiments, the mobile device 404 does not itself include a camera 832, but is able to interface with a separate camera through various means known in the art.

In some embodiments, the mobile device 404 may include a speaker (not shown) to playback predetermined audio messages or tones, such as to provide an images aligned indication 612. Finally, mobile device 404 may also include a location tracking receiver 836, which may interface with GPS satellites in orbit around the earth or indoor positioning systems to determine accurate location of the mobile device 404. The location tracking receiver 836 produces location coordinates 840 used by an operating system or application 816 to determine, record, and possibly display the mobile device position 408.

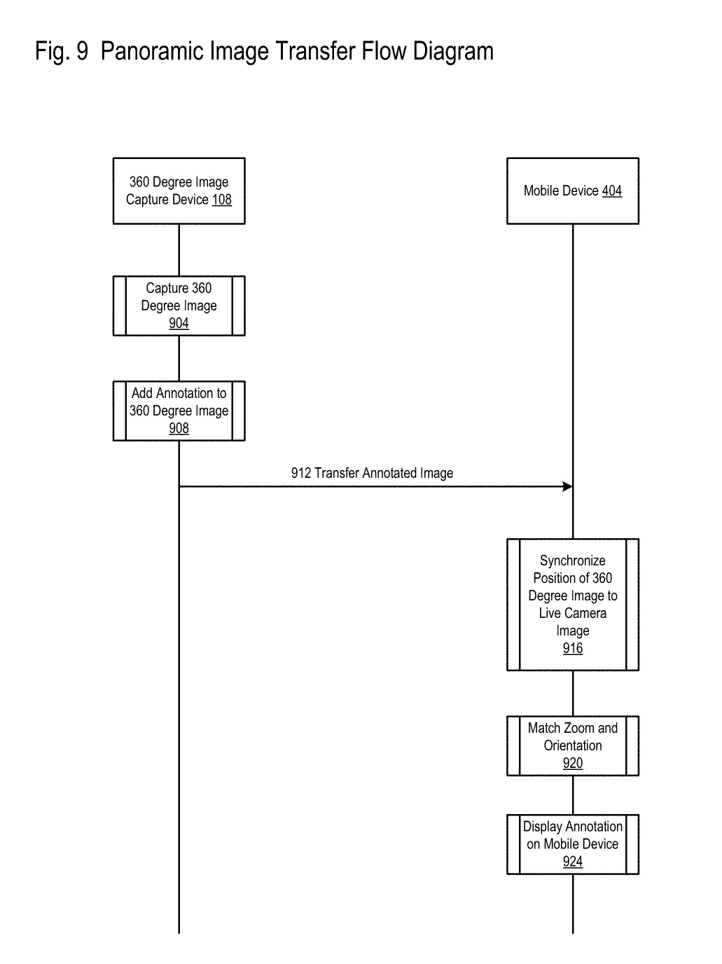

Referring now to FIG. 9, a flow diagram illustrating panoramic image transfer in accordance with embodiments of the present invention is shown. FIG. 9 illustrates interactions between a 360 degree image capture device 108 and the mobile device 404, for a case where a user adds annotation 304 directly to the captured 360 degree image on the 360 degree image capture device 108.

At block 904, a user captures a 360 degree image of a building location 104. The building location 104 is preferably a construction site of a building being built, remodeled, or reconstructed. A 360 degree image capture device 108 captures the 360 degree image 112.

At block 908, the user adds one or more annotations 304 to the captured 360 degree image 112. All of the one or more annotations are added within the frame of the 360 degree image 112 at selected coordinates, where each of the coordinates has a pitch 232 value and a yaw 236 value.

At block 912, once all annotations 304 have been added to the 360 degree image 112, the user transfers the annotated 360 degree image 308 to a mobile device 404. The mobile device 404 may be the user's mobile device 404, or a different user's mobile device 404.

At block 916, the user of the mobile device 404 synchronizes the position of the annotated 360 degree image 308 to a live camera image 504 of the mobile device 404. This means that the location of the 360 degree image capture device 116 will be the same as the location of the mobile device 404, in terms of the same building location 104, latitude/longitude, and height from a floor or the ground. Building location 104 is intended to differentiate between different floors of a building, such that a given latitude/longitude, and height from a first floor of a building is a different building location 104 from the given latitude/longitude, and height from a second floor of the same building.

At block 920, the user of the mobile device 404 adjusts the mobile device 404 live camera image zoom and orientation in order to match 608 the stored (annotated) 360 degree image 308. Assuming the 360 degree image capture device 108 and the mobile device 404 are both held upright to the same degree (i.e. roll 228 is identical between both devices), matching the orientation requires similar pitch 232 and yaw 236 values between both devices 108, 404.

At block 924, the mobile device displays the annotation 604 superimposed on the live camera image 504, at the same place within the building location.

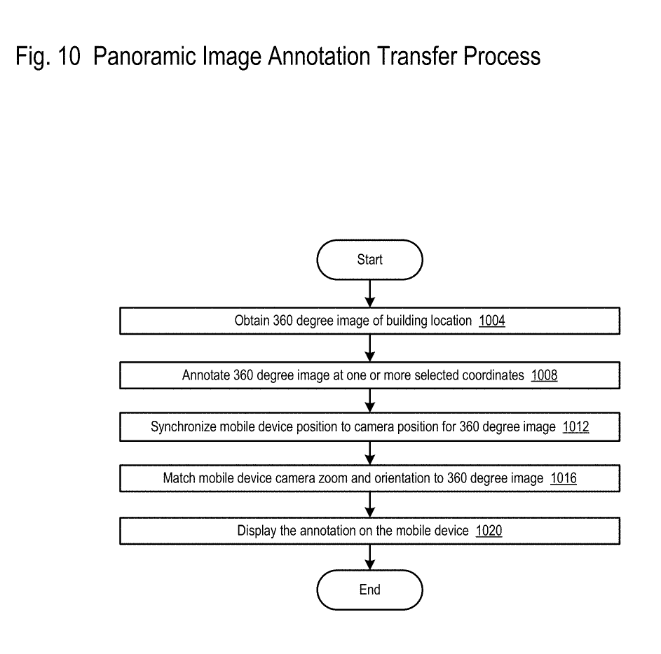

Referring now to FIG. 10, a flowchart illustrating a panoramic image annotation process in accordance with embodiments of the present invention is shown. Flow begins at block 1004.

At block 1004, a user obtains a 360 degree image 112 of a building location 104. Flow proceeds to block 1008.

At block 1008, a user annotates 304 the 360 degree image 112 at one or more selected coordinates 312. This creates the annotated 360 degree image 308. Flow proceeds to block 1012.

At block 1012, a user synchronizes a mobile device position 408 to a camera position 116 for the 360 degree image 112. Flow proceeds to block 1016.

At block 1016, zoom and orientation of a live camera image 504 for the mobile device 404 is matched to the zoom and orientation for the annotated 360 degree image 308. Flow proceeds to block 1020.

At block 1020, the displayed annotation 608 is shown on a display 828 of the mobile device 404. This points out to the user where the specific location for each displayed annotation 608 is on the live camera image 504. Flow ends at block 1020.

The various views and illustration of components provided in the figures are representative of exemplary systems, environments, and methodologies for performing novel aspects of the disclosure. For example, those skilled in the art will understand and appreciate that a component could alternatively be represented as a group of interrelated sub-components attached through various temporarily or permanently configured means. Moreover, not all components illustrated herein may be required for a novel embodiment, in some components illustrated may be present while others are not.

The descriptions and figures included herein depict specific embodiments to teach those skilled in the art how to make and use the best option. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

Finally, those skilled in the art should appreciate that they can readily use the disclosed conception and specific embodiments as a basis for designing or modifying other structures for carrying out the same purposes of the present invention without departing from the spirit and scope of the invention as defined by the appended claims.

We claim:

1. A method comprising:
obtaining, with a 360 degree image capture device, a 360 degree image at a building location;
annotating the 360 degree image at a selected coordinate;
synchronizing a position of a mobile device to a position of the 360 degree image capture device for the annotated 360 degree image;
matching a mobile device live camera image zoom and orientation to the annotated 360 degree image; and
displaying the annotation on the mobile device live camera image.

2. The method of claim 1, wherein the 360 degree image is one of a 360 degree photo or a photo export from a 360 degree laser scan.

3. The method of claim 2, wherein annotating the 360 degree image comprising:
adding one or more of text or graphics to the 360 degree image at one or more selected coordinates, the one or more selected coordinates each comprising a yaw and a pitch value.

4. The method of claim 3, wherein the one or more selected coordinates comprises a plurality of different coordinates within boundaries of the 360 degree image.

5. The method of claim 1, wherein the position of the mobile device is determined by one or more of:
designating the position on a floor plan of the building location;
receiving location information in a Quick Response Code;
receiving Global Positioning System coordinates of the mobile device; and
receiving an indoor positioning signal.

6. The method of claim 5, wherein the 360 degree image capture device position comprises one of an indication on the floor plan corresponding to the 360 degree image or a three dimensional location at the building location.

7. The method of claim 6, wherein matching the mobile device live camera image zoom and orientation to the 360 degree image comprises one of:
converting the annotated 360 degree image to a transparency overlay; and
matching the transparency overlay to the live camera image of the mobile device;
or
automatically aligning and adjusting the live camera image of the mobile device to the annotated 360 degree image; and
in response to the live camera image of the mobile device matching the annotated 360 degree image:
providing an indication to a user of the mobile device.

8. A system, comprising:
a 360 degree image capture device, configured to create a 360 degree image of a building location;
a mobile device, comprising:
a display;
a camera;
a memory, comprising:
an application; and
an annotated 360 degree image, received from one of the 360 degree image capture device or a computer configured to add annotation to the 360 degree image, the annotated 360 degree image comprises annotation at one or more selected coordinates of the 360 degree image; and
a processor, coupled to the memory, the display, and the camera, and configured to execute the application to:
synchronize a position of the mobile device to a 360 degree image capture device position for the annotated 360 degree image;
match a mobile device live camera view zoom and orientation to the annotated 360 degree image; and
display the annotation on the mobile device live camera view.

9. The system of claim 8, wherein the 360 degree image capture device is one of a 360 degree camera or a 360 degree laser scanner, wherein the annotation comprises one or more of text or graphics added to the 360 degree image at one or more selected coordinates, the one or more selected coordinates each comprises a yaw and a pitch value.

10. The system of claim 9, wherein the one or more selected coordinates comprises a plurality of different coordinates within boundaries of the 360 degree image.

11. The system of claim 8, wherein the position of the mobile device is determined by one or more of:
a user of the mobile device designates the position on a floor plan;
the processor receives location information in a Quick Response Code;
the processor receives Global Positioning System coordinates of the mobile device; and
the processor receives an indoor positioning signal.

12. The system of claim 11, wherein the 360 degree image capture device position for the 360 degree image comprises one of an indication on the floor plan corresponding to the 360 degree image or a three dimensional location at the building location corresponding to the 360 degree image.

13. The system of claim 12, wherein the processor matches the mobile device live camera view zoom and orientation to the annotated 360 degree image comprises one of:
the processor converts the annotated 360 degree image to a transparency overlay; and
the processor matches the transparency overlay to the live camera image of the mobile device;
or
the processor automatically aligns and adjusts the live camera image of the mobile device to the annotated 360 degree image; and
in response to the live camera image of the mobile device matches the annotated 360 degree image:
the processor provides an indication to a user of the mobile device.

14. The system of claim 8, wherein the 360 degree image has one of an equirectangular or cubic format.

15. A non-transitory computer readable storage medium configured to store instructions that when executed cause a processor to perform:
obtaining, with a 360 degree image capture device, a 360 degree image at a building location;
annotating the 360 degree image at a selected coordinate;
synchronizing a position of a mobile device to a position of the 360 degree image capture device for the annotated 360 degree image;
matching a mobile device live camera view zoom and orientation to the annotated 360 degree image; and
displaying the annotation on the mobile device.

16. The non-transitory computer readable storage medium of claim 15, wherein the 360 degree image is one of a 360 degree photo or a photo export from a 360 degree laser scan, wherein annotating the 360 degree image comprising:
adding one or more of text or graphics to the 360 degree image at one or more selected coordinates, the one or more selected coordinates each comprising a yaw and a pitch value.

17. The non-transitory computer readable storage medium of claim 16, wherein the one or more selected coordinates comprises a plurality of different coordinates within boundaries of the 360 degree image.

18. The non-transitory computer readable storage medium of claim 15, wherein the position of the mobile device is determined by one or more of:
designating the position on a floor plan;
receiving location information in a Quick Response Code;
receiving Global Positioning System coordinates of the mobile device; and
receiving an indoor positioning signal.

19. The non-transitory computer readable storage medium of claim 18, wherein the 360 degree image capture device position for the 360 degree image comprises one of an indication on the floor plan corresponding to the 360 degree image or a three dimensional location at the building location.

20. The non-transitory computer readable storage medium of claim 19, wherein matching the mobile device live camera view zoom and orientation to the annotated 360 degree image comprises one of:
converting the annotated 360 degree image to a transparency overlay; and
matching the transparency overlay to the live camera image of the mobile device;
or
automatically aligning and adjusting the live camera image of the mobile device to the annotated 360 degree image; and
in response to the live camera image of the mobile device matching the annotated 360 degree image:
providing an indication to a user of the mobile device.
